(19) United States
(12) Patent Application Publication
(10) Pub. No.: US 2020/0298255 A1
(43) Pub. Date: Sep. 24, 2020

(54) SPRAY HEAD ASSEMBLY, SPRAY HEAD DEVICE, AND UNMANNED AERIAL VEHICLE

(71) Applicant: SZ DJI TECHNOLOGY CO., LTD., Shenzhen (CN)

(72) Inventors: Le ZHOU, Shenzhen (CN); Xiaolong WU, Shenzhen (CN)

(21) Appl. No.: 16/893,050

(22) Filed: Jun. 4, 2020

Related U.S. Application Data
(63) Continuation of application No. PCT/CN2017/115243, filed on Dec. 8, 2017.

(51) Int. Cl. B05B 1/30; B05B 12/00

(52) U.S. Cl. CPC B05B 1/3006; B05B 12/002

(57) ABSTRACT

A spray head assembly includes a spray head body, a cover, a pressure relief adjustment member, and a seal assembly. The spray head body includes an inlet flow channel and an outlet flow channel. The cover is mounted at the spray head body and includes an accommodation chamber. The pressure relief adjustment member is configured to cooperate with the cover. The seal assembly is accommodated in the accommodation chamber and includes a seal valve plate, a connection member, and an elastic member. The seal valve plate is configured to connect the inlet flow channel and the outlet flow channel. The connection member is connected to the seal valve plate. The elastic member configured to provide an elastic force to the connection member, such that the seal valve plate is normally closed.

### CROSS-REFERENCE TO RELATED APPLICATION

This application is a continuation of International Application No. PCT/CN2017/115243, filed Dec. 8, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the spray system technology field of plant protection and, more particularly, to a spray head assembly, a spray head device, and an unmanned aerial vehicle (UAV).

### BACKGROUND

In related technology, a spray system is configured to spray liquids such as pesticides, fertilizers, water, etc., in the fields of agricultural production and plant protection. A spray head device of the spray system is configured to spray liquids to crop surface.

For the spray head device on the market, a valve structure is usually mounted at a valve body through a thread structure. When the spray head device is re-assembled after cleaning, forces for rotating and mounting the valve structure at the valve body are different. The different forces cause different liquid pressures required to open a seal structure, which may cause ununiform spraying. The current spray head does not have a specific pressure relief structure. The liquid flows to user's hands and surfaces of the spray head each time the pressure being released. The liquid is difficult to clean and may harm human health.

### SUMMARY

In accordance with the disclosure, there is provided a spray head assembly including a spray head body, a cover, a pressure relief adjustment member, and a seal assembly. The spray head body includes an inlet flow channel and an outlet flow channel. The cover is mounted at the spray head body and includes an accommodation chamber. The pressure relief adjustment member is configured to cooperate with the cover. The seal assembly is accommodated in the accommodation chamber and includes a seal valve plate, a connection member, and an elastic member. The seal valve plate is configured to connect the inlet flow channel and the outlet flow channel. The connection member is connected to the seal valve plate. The elastic member configured to provide an elastic force to the connection member, such that the seal valve plate is normally closed. The pressure relief adjustment member is configured to drive the seal valve plate through the connection member, to cause the seal assembly to switch between a first work position and a second work position. At the first work position, the seal valve plate is open, and the inlet flow channel and the outlet flow channel are in communication with each other. At the second work position, the seal valve plate is closed, and the communication between the inlet flow channel and the outlet flow channel is blocked.

### BRIEF DESCRIPTION OF THE DRAWINGS

FIG. 1 is an exploded perspective view of a spray head device according to an embodiment of the present disclosure.

FIG. 2 is a sectional view of the spray head device shown in FIG. 1.

FIG. 3 is a schematic perspective view of the cover shown in FIG. 1.

### DETAILED DESCRIPTION OF THE EMBODIMENTS

Technical solutions of the present disclosure are described in connection with the accompanying drawings in embodiments of the present disclosure. The described embodiments are only some embodiments not all embodiments of the present disclosure. All other embodiments obtained by those of ordinary skill in the art based on the described embodiments without creative work are within the scope of the present disclosure.

Exemplary embodiments are described in detail here, and examples of the embodiments are represented in the accompanying drawings. In the description of the accompanying drawings, same numbers in different drawings represent same or similar elements unless otherwise indicated. Implementations described in the following exemplary embodiments do not represent all implementations consistent with the present disclosure. In contrast, the implementations are merely examples of devices and methods consistent with some aspects of the present disclosure.

Terms used in the present disclosure are for a purpose of describing specific embodiments only, and are not intended to limit the present disclosure. Singular forms “a,” “the,” and “this” as used in the present disclosure and the appended claims are also intended to include plural forms, unless the context clearly indicates otherwise. The term “and/or” as used herein refers to and includes any or all possible combinations of one or more of related listed items.

A spray head assembly, a spray head device, and an unmanned aerial vehicle (UAV) are described in detail in connection with the accompanying drawings. In case of no conflict, following embodiments and features in the embodiments may be combined with each other.

In the embodiments of the present disclosure, the UAV includes a body, an arm, and a spray head device 100 mounted at the arm. The UAV may be used to spray liquids such as pesticides, fertilizers, water, etc., in the fields of agricultural production and plant protection.

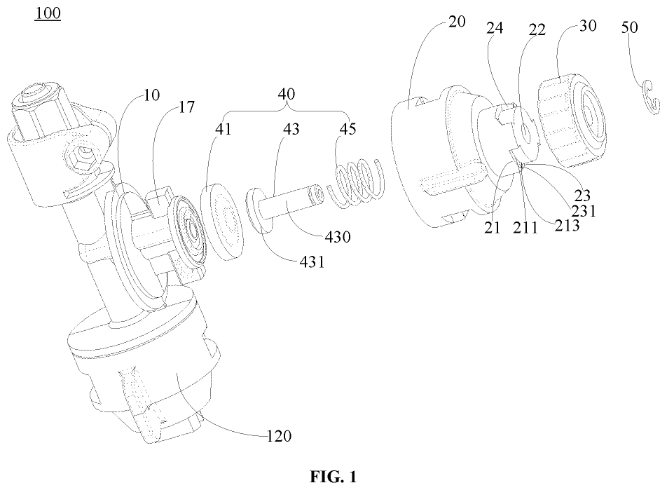

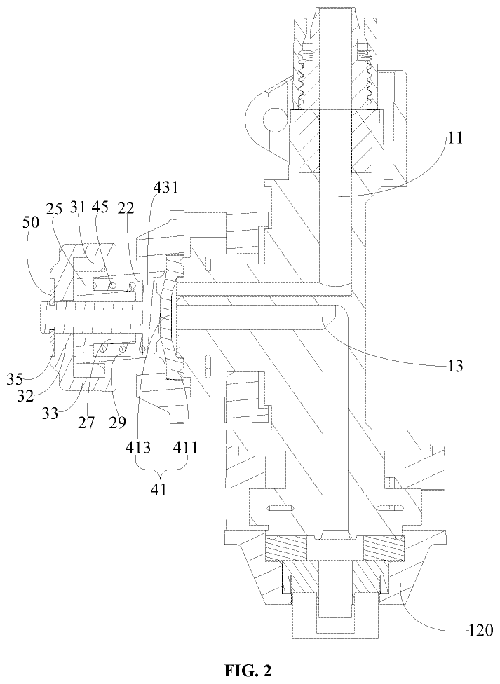

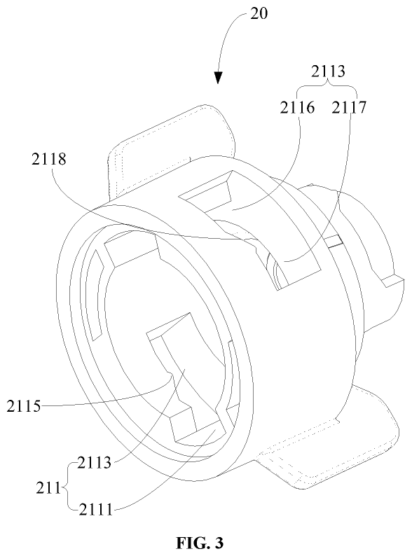

As shown in FIG. 1 to FIG. 3, the spray head device 100 includes the spray head assembly and a spray nozzle assembly 120. The spray nozzle assembly 120 may be detachably mounted at the spray head assembly. The spray nozzle assembly 120 is connected to an outlet flow channel 13.

The spray head assembly includes a spray head body 10, a cover 20, a pressure relief adjustment member 30, and seal assembly 40. The spray head body 10 includes an inlet flow channel 11 and the outlet flow channel 13. The cover 20 is mounted at the spray head body 10. The cover 20 includes an accommodation chamber 22. The pressure relief adjustment member 30 cooperates with the cover 20. The seal assembly 40 is placed in the accommodation chamber 22. The seal assembly 40 includes a seal valve plate 41, a connection member 43, and an elastic member 45. The seal valve plate 41 is configured to block communication between the inlet flow channel 11 and the outlet flow channel 13. The pressure relief adjustment member 30 is configured to drive the seal valve plate 41 through the connection member 43. The elastic member 45 is configured to provide an elastic force to the connection member 43, such that the seal valve plate 41 is normally closed.

When the pressure relief adjustment member 30 is operated, the pressure relief adjustment member 30, through the connection member 43, causes the seal assembly 40 to switch between a first work position and a second work position. When the seal assembly 40 is at the first work position, the seal valve plate 41 is open, and the inlet flow channel 11 communicates with the outlet flow channel 13. When the seal assembly 40 is at the second work position, the seal valve plate 41 is closed, and the communication between the inlet flow channel 11 and the outlet flow channel 13 is blocked.

Due to the elastic member 45, the seal valve plate 41 is normally closed. The inlet flow channel 11 of the spray head body 10 is in communication with a pump. When the pump pumps liquid to the inlet flow channel 11, liquid pressure causes the seal valve plate 41 to open. The inlet flow channel 11 and the outlet flow channel 13 are then in communication with each other, and the spray head device can spray liquids such as pesticides, water, etc. To release the pressure, the pressure relief adjustment member 30 is operated to switch the seal assembly 40 from the second work position to the first work position. The seal valve plate is opened to release the pressure. This effectively avoids the liquids such as the pesticides, and the water, etc., from flowing to hands of an operator and a surface of the spray head device.

The seal assembly 40 has the definite first work position and second work position. When the spray head assembly is re-assembled after cleaning, the seal assembly 40 is at the defined second work position, and the elastic member 45 provides a constant elastic force to the connection member 43. As such, the connection member 43 applies a consistent pressing force to the seal valve plate 41. When spraying, the liquid pressure, which opens the seal valve plate 41, is also consistent. The spraying is uniform.

In an embodiment, the spray head body 10 includes a pair of buckles 17. An inner wall of the accommodation chamber 21 of the cover 20 includes sliding slots 211 cooperating with the buckles 17, correspondingly. Each sliding slot 211 includes a first sliding slot 2111 through an end surface of the cover 20 and a second sliding slot 2113. The first sliding slot 2111 and the second sliding slot 2113 form a certain angle. The buckle 17 slides from the end surface of the cover 20 through the first sliding slot 2111 into the second sliding slot 2113. An inner wall of the second sliding slot 2113 includes a positioning portion 2115 for limiting the buckle 17. Assembling is convenient and reliable.

In the above-described embodiment, an extension direction of the first sliding slot 2111 is perpendicular to the end surface of the cover 20. The second sliding slot 2113 is perpendicular to the first sliding slot 2111. The second sliding slot 2113 includes a wider first section 2116 and a narrower second section 2117. The positioning portion 2115 at the inner wall of the second sliding slot 2113 is located between the first section 2116 and the second section 2117. The first section 2116 is connected to the second section 2117. The positioning portion 2115 protrudes from an inner wall of the second section 2117 and limits the buckle 17 within the second section 2117, so as to fix the cover 20 to the spray head body 10. A side of the positioning portion 2115 adjacent to the first section 2116 is a guide surface 2118. The guide surface 2118 facilitates the buckle 17 to slide from the first section 2116 into the second section 2117.

During assembling, the buckle 17 of the spray head body 10 is first inserted into the first sliding slot 2111 of the cover 20. The cover 20 is then rotated relative to the spray head body 10. The buckle 17 first enters the first section 2116 of the second sliding slot 2113, then enters the second section 2117 by guidance of the guide surface 2118, and is held by the positioning portion 2115. As such, the cover 20 is mounted to the spray head body 10.

In an embodiment, an end of the connection member 43 is fixedly connected to the pressure relief adjustment member 30. The other end of the connection member 43 has an abutting portion 431. The abutting portion 431 abuts against the seal valve plate 41. In the embodiment, an end of the connection member 43 is fixed to the pressure relief adjustment member 30 through a retaining ring 50. That is, the end of the connection member 43 passes through the pressure relief adjustment member 30, and the retaining ring 50 is placed at the end of the connection member 43. An end surface of the pressure relief adjustment member 30 includes a concave slot 35, and the retaining ring 50 is in the concave slot 35. The retaining ring 50 is fixed to both the connection member 43 and the pressure relief adjustment member 30. In another embodiment, the connection member 43 is connected to the pressure relief adjustment member 30 by a fastener, such as screws, or by buckles, etc., which is not limited here.

In other embodiments, other manners for connecting the connection member 43 to the pressure relief adjustment member 30 and the seal valve plate 41 may be used. In one manner, an end of the connection member 43 is movably connected to the pressure relief adjustment member 30, and the other end is fixedly connected the seal valve plate 41. In another manner, the connection member 43 and the pressure relief adjustment member 30 are formed integrally, and the connection member 43 is detachably connected to the seal valve plate 41. In another manner, the connection member 43 is detachably connected to the pressure relief adjustment member 30, and the connection member 43 and the seal valve plate 41 are formed integrally. The connection manner may be any manner as long as the pressure relief adjustment member 30 can be operated to drive the connection member 43 to realize the switching of the seal assembly 40 between the first work position and the second work position.

In an embodiment, the elastic member 45 abuts against the cover 20 and the abutting portion 431. The elastic member 45 is configured to apply an elastic force to the abutting portion 431 in a direction toward the seal valve plate 41. In this embodiment, the connection member 43 includes a rod-shaped main body 430. The main body 430 is cylindrical, and may also be in another shape. The abutting portion 431 is placed at an end of the main body 430 and protrudes from the main body 430 along a circumstantial direction. An end of the abutting portion 431 is an annular surface surrounding the main body portion 430. The elastic member 45 abuts against the annular surface of the abutting portion 431. The other surface of the abutting portion 431 abuts against the seal valve plate 41.

In another embodiment, the elastic member 45 may be fixedly or movably connected to the cover 20 and the connection member 43. The elastic member 45 is configured to apply the elastic force to the abutting portion 431 in a direction toward the seal valve plate 41. For example, the elastic member 45 may be connected to the cover 20 and the connection member 43 by glue bonding. Other connection manners may be used, and the present disclosure is not limited here.

In an embodiment, the pressure relief adjustment member 30 includes an adjustment portion 31. The cover 20 includes a first working portion 21 and a second working portion 23 cooperating with the adjustment portion 31. When the adjustment portion 31 abuts against the first working portion 21, the seal valve plate 41 is open, and the inlet flow channel 11 is in communication with the outlet flow channel 13. When the adjustment portion 31 abuts against the second working portion 23, the seal valve plate 41 block the communication between the inlet flow channel 11 and the outlet flow channel 13. To release the pressure, the operator operates the pressure relief adjustment member 30 to move the adjustment portion 31 from the second working portion 23 to the first working portion 21. The seal valve plate 41 is open to release the pressure, and the operation is convenient.

Further, the pressure relief adjustment member 30 includes a body 32 cooperating with the connection member 43 and an edge portion 33 at a periphery of the body 32. The edge portion 33 is easily to hold and operate. The adjustment portion 31 protrudes from the body 32 or the edge portion 33. In other embodiments, the edge portion 33 may be omitted, and the adjustment portion 31 protrudes from the body 32.

In an embodiment, the first working portion 21 and the second working portion 23 are concave from the end surface of the cover 20. In this embodiment, the first working portion 21 and the second working portion 23 are at a surrounding wall of the cover 20. In other embodiments, the first working portion 21 and the second working portion 23 may also protrude from different positions at the surrounding wall of the cover 20. The present disclosure is not limited here.

In an embodiment, the first working portion 21 has a first surface 211 cooperating with the adjustment portion 31. The second working portion 23 has a second surface 231 cooperating with the adjustment portion 31. The first surface 211 and the second surface 231 are parallel to each other. A transition surface 24 is between the first surface 211 and the second surface 231. The transition surface 24 is an inclined surface connecting the first surface 211 and the second surface 231. The transition surface 24 may also be a curved surface. To release the pressure, the operator rotates the pressure relief adjustment member 30, such that the adjustment portion 31 slides from the second surface 231 through the transition surface 24 to the first surface 211. At this point, the seal valve plate 41 is open, and the pressure is released.

In another embodiment, the first working portion 21 has the first surface 211 cooperating with the adjustment portion 31. The second working portion 23 has the second surface 231 cooperating with the adjustment portion 31. The first surface 211 and the second surface 231 are parallel to each other and connected by the transition surface 24. The transition surface 24 is perpendicular to the first surface 211 and the second surface 231. To release the pressure, the operator first pulls the pressure relief adjustment member 30 in a direction away from the seal valve plate 41 until the end of the adjustment portion 31 is aligned with the first surface 211. The operator then rotates the pressure relief adjustment member 30, such that the adjustment portion 31 abuts the first surface 211. At this point, the seal valve plate is open, and the pressure is released.

In another embodiment, the first working portion 21 has the first surface 211 cooperating with the adjustment portion 31. The second working portion 23 has the second surface 231 cooperating with the adjustment portion 31. The second surface 231 is inclined with respect to the first surface 211, such that the adjustment portion 31 slides along the second surface 231 with the force applied by the elastic member 45. In this situation, the transition surface may or may not be provided between the second surface 231 and the first surface 211.

A position limiting portion 213 is provided at the first surface 211 to limit the adjustment portion 31 at the first surface 211, such that the adjustment portion 31 does not slide to the second surface 231 under the elastic force of the elastic member 45. The position limiting portion 213 is a convex portion, and, in some embodiments, a surface of the convex portion is a smooth arc surface, which facilitates the switching of the pressure relief adjustment member 30 between the first surface 211 and the second surface 231. The position limiting portion 213 may alternatively be a square, etc., and the present disclosure is not limited here. In the embodiment, the position limiting portion 213 is adjacent to the transition surface 24.

In an embodiment, the pressure relief adjustment member 30 includes two opposite adjustment portions 31. The cover 20 includes two pairs of the first working portions 21 and the second working portions 23. According to specific needs, the pressure relief adjustment member 30 may include one, three, or more than three adjustment portions 31. The cover 20 may include one, three, or more than three pairs of the first working portions and the second working portions 23.

Further, the cover 20 has a cooperation portion 25. An end of the elastic member 45 abuts against the cooperation portion 25. The other end of the elastic member 45 abuts against the abutting portion 431 of the connection member 43. To release the pressure, the operator rotates the pressure relief adjustment member 30. As the adjustment portion 31 slides from the second surface 231 to the first surface 211, the abutting portion 431 moves toward the cooperation portion 25. The elastic member 45 deforms elastically as compressed by the abutting portion 431, and the seal valve plate 41 switches from a closed state to an open state. The cooperation portion 25 is at an end of the cover and protrudes from the inner wall of the accommodation chamber of the cover 20. In this embodiment, the cooperation portion 25 has a ring shape. Correspondingly, the elastic member 45 also has a ring shape, such that the elastic member 45 can uniformly apply an elastic force to the abutting portion 431 in a direction toward the seal valve plate 41.

In an embodiment, an end of the cover 20 extends toward the seal valve plate 41 to form a position limiting wall 27. The position limiting wall 27 and the inner wall of the accommodating chamber 22 surround to form an accommodation groove 29 for accommodating the elastic member 45. The cooperation portion 25 is at an end of the accommodation groove 29. The size of the accommodation groove 29 is slightly larger than the elastic member 45, such that the elastic member 45 does not interfere the position limiting wall 27 and the inner wall of the accommodation chamber 22 when the elastic member 45 is compressed and deforms. The elastic member 45 is in the accommodation groove 29. The elastic member 45 does not move under limitation of the accommodation groove 29 during working.

The elastic member 45 includes at least one of a spring, an elastic rubber tube, or an elastic metal sheet. As long as the elastic member 45 can provide an elastic force to the connection member 43, the elastic member 45 is not limited to the above examples.

In an embodiment, the seal valve plate 41 includes a connection portion 411 clamped by the spray head body 10 and the cover 20, and a seal portion 413 facing the inlet flow channel 11 and the outlet flow channel 13. The cover 20 includes an annular slot. The connection portion 411 of the seal valve plate 41 is located in the annular slot, and is clamped and fixed by the spray head body 10 and the cover 20.

In the specification, relational terms such as first and second are only used to distinguish one entity or operation from another entity or operation, and do not necessarily require or imply any such actual relationship or orders between these entities or operations. The terms “include,” “contain,” or any other variation thereof, are intended to cover non-exclusive inclusion, such that a process, method, article, or device that includes a series of elements includes not only those elements, but also other elements not explicitly listed, or includes elements that are inherent to such a process, method, article, or device. Without further restrictions, elements associated with the clause “including a . . . ” do not exclude existence of other similar elements in the process, method, article or device including the elements.

The methods and devices provided by the embodiments of the present disclosure have been described in detail above. Specific examples have been used herein to explain the principles and implementations of the present disclosure. The descriptions of the above embodiments are only used to help understand the method and core ideas of the present disclosure. Those of ordinary skill in the art should understand that, according to the spirits of the present disclosure, changes may be made to the specific implementation and the scope of application. The contents of this specification should not be interpreted as limiting the present disclosure.

What is claimed is:

1. A spray head assembly comprising:
a spray head body including an inlet flow channel and an outlet flow channel;
a cover mounted at the spray head body and including an accommodation chamber;
a pressure relief adjustment member configured to cooperate with the cover; and
a seal assembly accommodated in the accommodation chamber and including:
a seal valve plate configured to connect the inlet flow channel and the outlet flow channel;
a connection member connected to the seal valve plate; and
an elastic member configured to provide an elastic force to the connection member, such that the seal valve plate is normally closed;
wherein the pressure relief adjustment member is configured to drive the seal valve plate through the connection member, to cause the seal assembly to switch between:
a first work position, at which the seal valve plate is open, and the inlet flow channel and the outlet flow channel is in communication with each other; and
a second work position, at which the seal valve plate is closed, and the communication between the inlet flow channel and the outlet flow channel is blocked.

2. The spray head assembly of claim 1, wherein an end of the connection member is fixedly connected to the pressure relief adjustment member, and another end of the connection member includes an abutting portion configured to abut against the seal valve plate.

3. The spray head assembly of claim 2, wherein the elastic member abuts against the cover and the abutting portion, and is configured to apply an elastic force to the abutting portion in a direction toward the seal valve plate.

4. The spray head assembly of claim 2, wherein the elastic member is connected to the cover and the connection member, and configured to apply an elastic force to the abutting portion in a direction toward the seal valve plate.

5. The spray head assembly of claim 1, wherein an end of the connection member is movably connected to the pressure relief adjustment member, and another end of the connection member is fixedly connected to the seal valve plate.

6. The spray head assembly of claim 1, wherein the connection member and the pressure relief adjustment member are formed integrally, and the connection member is detachably connected to the seal vale plate.

7. The spray head assembly of claim 1, wherein the connection member is detachably connected to the pressure relief adjustment member, and the connection member and the seal valve plate are formed integrally.

8. The spray head assembly of claim 1, wherein:
the pressure relief adjustment member includes an adjustment portion;
the cover includes a first working portion and a second working portion configured to cooperate with the adjustment portion;
when the adjustment portion abuts against the first working portion, the seal valve plate is open, and the inlet flow channel is in communication with the outlet flow channel; and
when the adjustment portion abuts against the second working portion, the seal valve plate blocks the communication between the inlet flow channel and the outlet flow channel.

9. The spray head assembly of claim 8, wherein the pressure relief adjustment member includes a body configured to cooperate with the connection member, and the adjustment portion protrudes from the body.

10. The spray head assembly of claim 8, wherein the first working portion and the second working portion are concave from an end surface of the cover.

11. The spray head assembly of claim 10, wherein:
the first working portion has a first surface configured to cooperate with the adjustment portion;
the second working portion has a second surface configured to cooperate with the adjustment portion; and
the second surface is inclined with respect to the first surface.

12. The spray head assembly of claim 10, wherein:
the first working portion has a first surface configured to cooperate with the adjustment portion;
the second working portion has a second surface configured to cooperate with the adjustment portion; and
the cover further includes a transition surface between the first surface and the second surface.

13. The spray head assembly of claim 12, wherein the first working portion further includes a position limiting portion at the first surface to hold the adjustment portion at the first surface.

14. The spray head assembly of claim 13, wherein the position limiting portion includes a convex portion.

15. The spray head assembly of claim 13, wherein the position limiting portion is adjacent to the transition surface.

16. The spray head assembly of claim 12, wherein the transition surface includes an inclined surface connecting the first surface and the second surface.

17. The spray head assembly of claim 1, wherein:
the pressure relief adjustment member includes two adjustment portions; and
the cover includes two pairs of first working portion and second working portion configured to cooperate with the two adjustment portions, respectively;

18. The spray head assembly of claim 1, wherein:
the spray head body includes a buckle;
the cover includes a sliding slot at an inner wall of the accommodation chamber and configured to cooperate with the buckle;
the sliding slot includes a first sliding slot through an end surface of the cover and a second sliding slot connected to the first sliding slot;
the buckle is configured to slide from the end surface of the cover through the first sliding slot into the second sliding slot; and
the second sliding slot includes a positioning part at an inner wall of the second sliding slot and configured to limit the buckle.

19. The spray head assembly of claim 18, wherein an extension direction of the first sliding slot is perpendicular to the end surface of the cover, and the second sliding slot is perpendicular to the first sliding slot.

20. The spray head assembly of claim 18, wherein:
the second sliding slot includes a wider first section and a narrower second section; and
the positioning part is located between the first section and the second section.
